(19) United States
(12) Patent Application Publication
(10) Pub. No.: US 2007/0083570 A1
(43) Pub. Date: Apr. 12, 2007

(54) File system versioning using a log

(76) Inventor: Samuel A. Fineberg, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/247,475

(22) Filed: Oct. 11, 2005

(51) Int. Cl. G06F 17/30

(52) U.S. Cl. 707/203

(57) ABSTRACT

In one embodiment, a computing system comprises one or more processors, and a memory module communicatively connected to the one or more processors. The memory module comprises logic instructions which, when executed on the one or more processors configure the one or more processors to receive, in a computer-based data storage system, a data operation that changes the contents of a file system, log the data operation in a log, and use the log in a versioning file system to create versions of the file system objects.

### TECHNICAL FIELD

This application relates to electronic computing, and more particularly to file system versioning.

### BACKGROUND

Effective collection, management, and control of information have become a central component of modern business processes. To this end, many businesses, both large and small, now implement computer-based information management systems.

Data management is an important component of computer-based information management systems. Many users implement storage networks to manage data operations in computer-based information management systems. Storage networks have evolved in computing power and complexity to provide highly reliable, managed storage solutions that may be distributed across a wide geographic area.

The ability to maintain data accurate data in the event of a failure is an important feature of a storage system. A storage device or network may maintain redundant copies of data to safeguard against the failure of a single storage device, medium, or communication connection. Upon a failure of the first storage device, medium, or connection, the storage system may then locate and/or retrieve a copy of the data contained in a second storage device or medium. The ability to duplicate and store the contents of the storage device also facilitates the creation of a fixed record of contents at the time of duplication. This feature allows users to recover a prior version of inadvertently edited or erased data.

Maintaining redundant copies of data records requires a scheme to track changes to data records. Further, maintaining multiple versions of a file system object may facilitate restoring the object to a previous point in time.

### SUMMARY

In one embodiment, a computing system comprises one or more processors, and a memory module communicatively connected to the one or more processors. The memory module comprises logic instructions which, when executed on the one or more processors configure the one or more processors to receive, in a computer-based data storage system, a data operation that changes the contents of a file system, log the data operation in a log, and use the log in a versioning file system to create versions of the file system objects.

### BRIEF DESCRIPTION OF THE DRAWINGS

FIG. 1 is a schematic illustration of one embodiment of a computing system adapted to implement file system logging.

FIG. 2 is a schematic illustration of one embodiment of a storage cell.

FIG. 3 is a flowchart illustrating operations in one embodiment of a method of file system logging.

FIG. 4 is a flowchart illustrating operations in one embodiment of a method of using the log created in FIG. 3 to create a transactional versioned data store.

### DETAILED DESCRIPTION

Described herein are exemplary system and methods for file system versioning in a computer-based data storage system. The methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

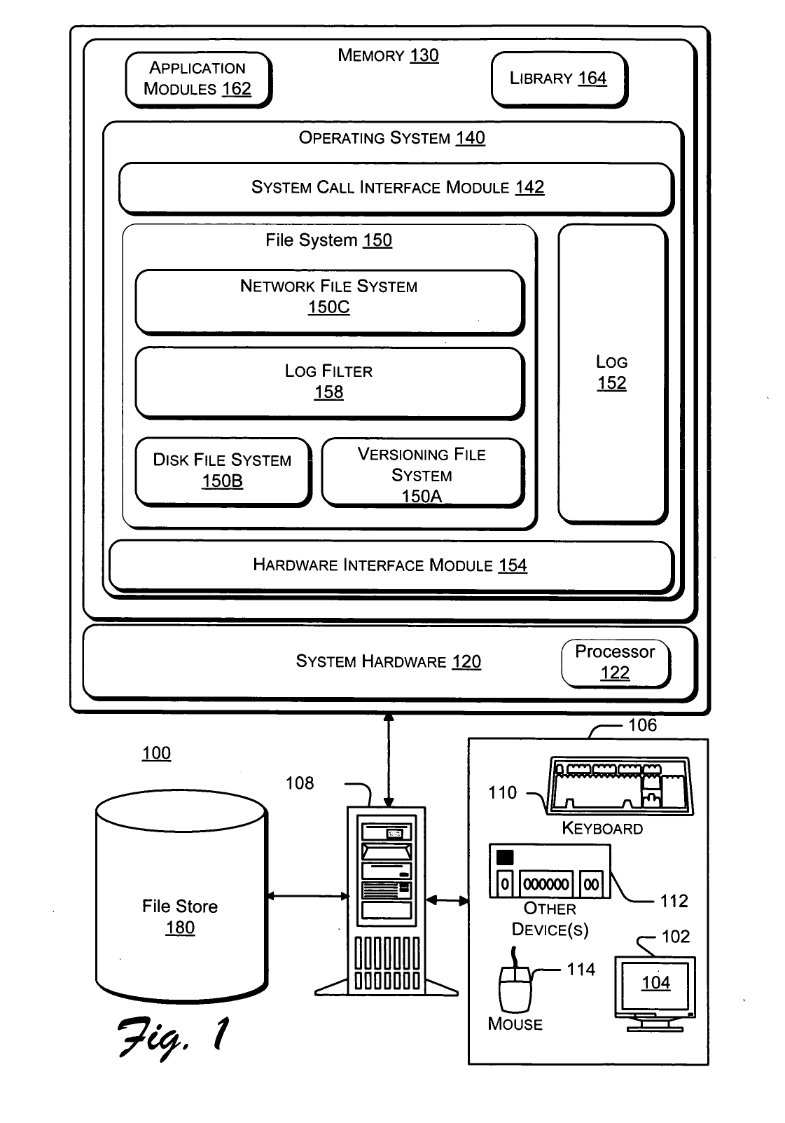

In one embodiment, the systems and methods described herein may be implemented in an archiving storage system such as, for example the HP StorageWorks Reference Information Storage System (RISS) commercially available from Hewlett Packard Corporation of Palo Alto, Calif., USA. FIG. 1 is a schematic illustration of an exemplary computer system 100 adapted to perform file system logging. The computer system 100 includes a computer 108 and one or more accompanying input/output devices 106 including a display 102 having a screen 104, a keyboard 110, other I/O device(s) 112, and a mouse 114. The other device(s) 112 can include a touch screen, a voice-activated input device, a track ball, and any other device that allows the system 100 to receive input from a developer and/or a user. The computer 108 includes system hardware 120 and random access memory and/or read-only memory 130. A file store 180 is communicatively connected to computer 108.

Memory 130 includes an operating system 140 for managing operations of computer 108. In one embodiment, operating system 140 includes a hardware interface module 154 that provides an interface to system hardware 120. In addition, operating system 140 may include (or communicate with) one or more file systems which manage many file system objects. File system objects may include data files as well as non-file objects such as, e.g., directories, folders, links, device nodes, and reparse points. In one embodiment operating system may include a file system stack 150, which in turn may include a disk file system 150B that manages file system objects at the block level, a versioning file system 150A that stores multiple versions of file system objects, and a network file system 150C that allows file system objects to be accessed across a network. Operating system 140 may further include a log 152. Operating system 140 further includes a system call interface module 142 that provides an interface between the operating system 140 and one or more application modules 162 and/or libraries 164.

In operation, one or more application modules 162 and/or libraries 164 executing on computer 108 make calls to the system call interface module 142 to execute one or more commands on the computer's processor. The system call interface module 142 invokes the services of the file system stack 150 to manage the files required by the command(s). The file system stack 150, in turn, invokes the services of the hardware interface module 154 to interface with the system hardware 120.

The particular embodiment of operating system 140 is not critical to the subject matter described herein. Operating system 140 may be embodied as a UNIX operating system or any derivative thereof (e.g., Linux, Solaris, etc.) or as a Windows® brand operating system.

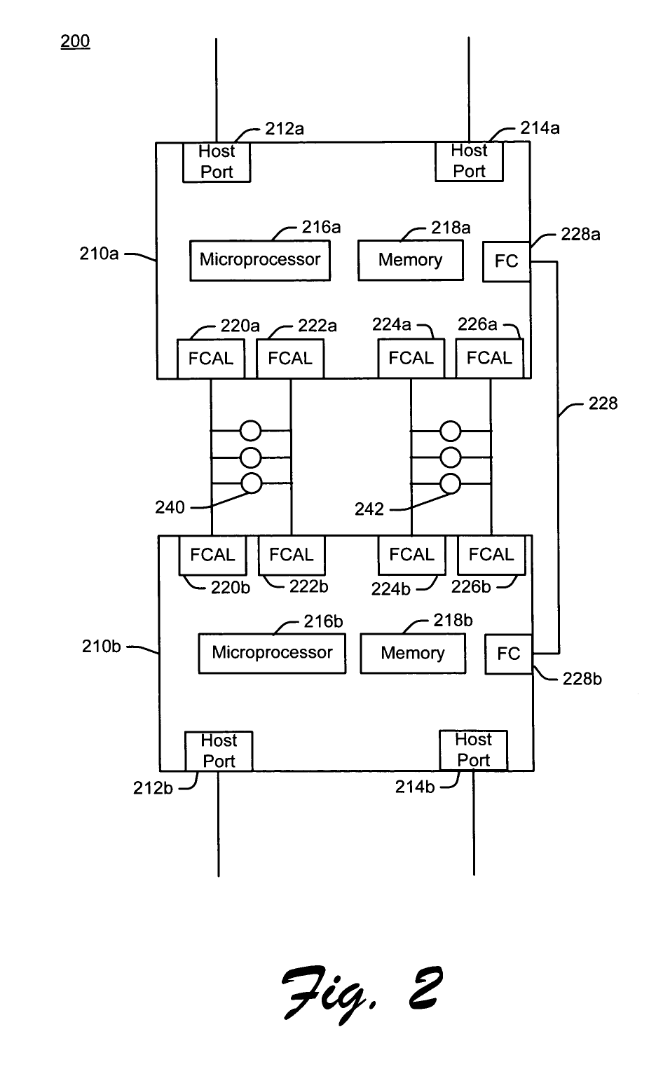

In one embodiment, the file store 180 may be embodied as, for example, a storage cell. FIG. 2 is a schematic illustration of an exemplary embodiment of a storage cell 200. It will be appreciated that the storage cell 200 depicted in FIG. 2 is merely one exemplary embodiment, which is provided for purposes of explanation. The particular details of the storage cell 200 are not critical. Referring to FIG. 2, storage cell 200 includes two Network Storage Controllers (NSCs), also referred to as array controllers, 210a, 210b to manage the operations and the transfer of data to and from one or more arrays of disk drives 240, 242. Array controllers 210a, 210b may be implemented as plug-in cards having a microprocessor 216a, 216b, and memory 218a, 218b. Each array controller 210a, 210b may include dual host adapter ports 212a, 214a, 212b, 214b that provide an interface to a host, i.e., through a communication network such as a switching fabric. In a Fibre Channel (FC) implementation, host adapter ports 212a, 212b, 214a, 214b may be implemented as FC N_Ports. Each host adapter port 212a, 212b, 214a, 214b manages the login and interface with a switching fabric, and is assigned a fabric-unique port ID in the login process. The architecture illustrated in FIG. 2 provides a fully-redundant storage cell. This redundancy is entirely optional; only a single array controller is required to implement a storage cell.

Each array controller 210a, 210b further includes a communication port 228a, 228b that enables a communication connection 238 between the NSCs 210a, 210b. The communication connection 238 may be implemented as a FC point-to-point connection, or pursuant to any other suitable communication protocol.

In an exemplary implementation, array controllers 210a, 210b may include a plurality of Fiber Channel Arbitrated Loop (FCAL) ports 220a-226a, 220b-226b that implements an FCAL communication connection with a plurality of storage devices, e.g., sets of disk drives 240, 242. While the illustrated embodiment implement FCAL connections with the sets of disk drives 240, 242, it will be understood that the communication connection with sets of disk drives 240, 242 may be implemented using other communication protocols. For example, rather than an FCAL configuration, a FC switching fabric may be used.

Referring back to FIG. 1, the network file system 150C may be embodied in accord with any number of file system protocols such as, e.g., Network File System (NFS) protocol, Remote File Sharing protocol (RFS), Andrew File System (AFS) protocol, Distributed Data Management (DDM) protocol, Common Internet File System (CIFS), File Transfer Protocol (FTP), and the like. Disk file system 150B may be embodied in accord with any number of file system protocols such as, e.g., NTFS, FAT, UFS, ext2fs, ext3fs, reiserfs, Veritas file system, or the like. Versioning file system 150A may be embodied in accord with any number of versioning file system protocols such as, e.g., Wayback, CVFS, ext3cow, or the Elephant file system; or with any number of versioning object stores such as, e.g., the Concurent Versioning System (CVS), Clearcase, Visual SourceSafe, or Content Services Framework Repository (CSF-R). File systems and object stores may optionally support transactional semantics, where a set of operations may be applied in an all or none fashion. Transactional support enables the file system to be more robust, because the file system always maintains a consistent state by preventing sets of changes from being partially applied.

In one embodiment, file system stack 150 may include a log filter 158, e.g., at an interface between the operating system 140 and the one or more file systems 150A, 150B, 150C. The log filter may be implemented as logic instructions which, when executed by a processor, cause the processor to log in memory 130 or on the file store 180 operations that result in changes to one or more file systems 150A. In one embodiment, the log filter 158 captures operations flowing between two file system interfaces, passes the operations from the higher file system layer to the lower file system layer, and records in a log those operations flowing between the layers that modify the underlying file system. Therefore, it is possible to have a log filter inserted at any point in the operating system's file system stack 150. For example, the log filter 158 could appear as shown in FIG. 1 between the network file system 150C and the disk file system 150B. It could also appear between the system call interface module 142 and the network file system layer 150C. Many other embodiments are possible. The log 152 may be used by a versioning file system 150A to create one or more versions of the data managed by the one or more file systems 150A, 150B, 150C. The versions may be stored in archived storage, e.g., on file store 180 on this computing system or on another remotely accessed computing system.

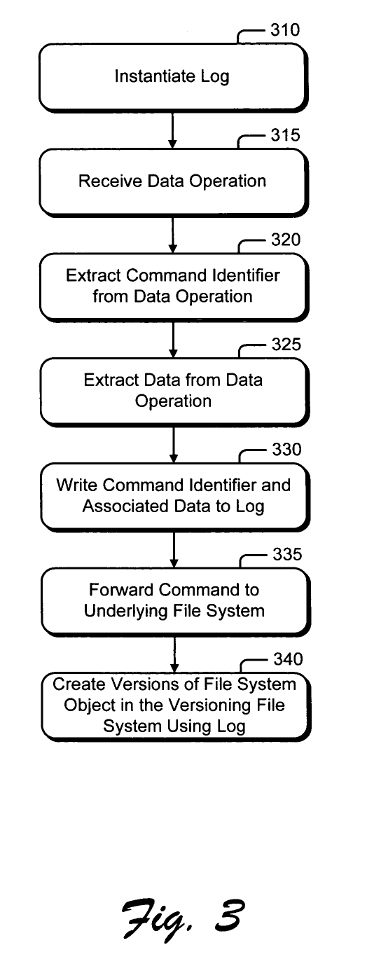

FIG. 3 is a flowchart illustrating operations in one embodiment of a method of file system logging by computer system 100. Referring briefly to FIG. 3, at operation 310 a memory log is instantiated. In one embodiment a memory log may be embodied as data stored in an active memory such as, e.g., memory 130 of computing system 130. In an alternate embodiment, a memory log may be embodied as data stored on a persistent memory such as, e.g., the file store 180.

At operation 315 a data operation is received in the log filter 158. In one embodiment the data operation may be any data operation that changes the contents of a file system such as, e.g., a write operation, a delete operation, or the like. The data operation may intercepted by the log filter 158 when the data operation is from a higher layer in the operating system or file system to a lower layer in the file system. This higher layer may include the system call interface 142, a network file system 150C, a disk file system 150B or even a versioning file system 150A. The data operation may originate from an application module executing on the computing system 100 such as, for example, application module 162. Alternatively, the data operation may originate from a remote computing device coupled to the computing system 100 via a communication network.

At operations 320 and 325, respectively, the command identifier and data associated with the data operation are extracted from the data operation. In one embodiment, log filter 158 extracts command identifiers and associated data only from data operations that change the file system object on which the data operation operates. For example, the log filter may extract command identifiers from create, write, truncate, and delete operations as well as file system object metadata modifying operations such as rename, change file permissions, change file owner, and change file attributes. Log filter 158 may also extract command identifiers from open and close operations directed at a specific file system object. Log filter 158 may extract additional information associated with the data operation including, for example, a timestamp, an application identifier that identifies the application that originated the data operation, and/or a node or device identifier that identifies the computing node or device hosting the application that originated the request.

At operation 330 the command identifier and associated data extracted in operations 320-325 are written to the log 152, and at operation 335 the command identifier and the associated data are forwarded to an underlying file system. Referring back to FIG. 1, the underlying file system may be embodied as either a disk file system 150B, a versioning file system 150A, or a network file system 150C. In one embodiment, the log may be implemented as time-sequenced listing of commands and associated data managed by the file systems 150A, 150B, 150C.

At operation 340, one or more versions of the file system object are created using the log 152. In one embodiment, operation 340 may be implemented by the log filter 158. In alternate embodiments, operation 340 may be implemented by the versioning file system 150A or by another process.

In one embodiment the system is adapted to generate a mirror of the log, which may reside on the same file store 180 or on a remote file store coupled to the system 100 via a communication network. The mirror may also be created using the operations of FIG. 3.

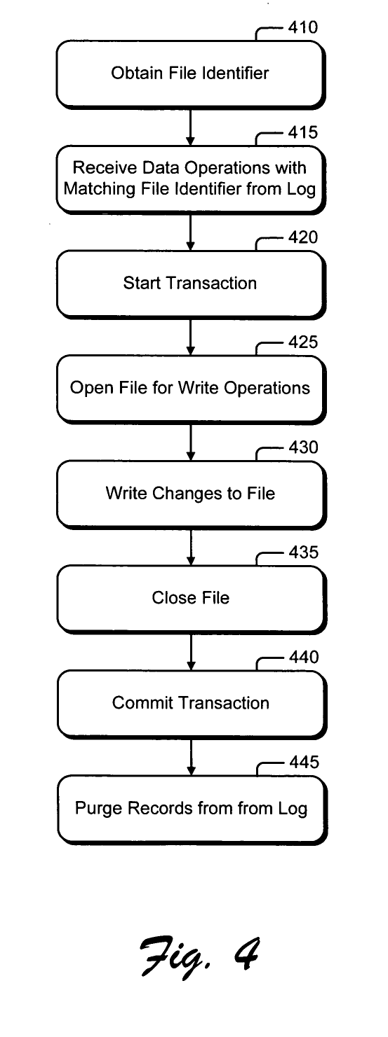

Operation 335 is explained in greater detail in FIG. 4, which is a flowchart illustrating operations in one embodiment of a method of using the log created in FIG. 3 to create a versioned data store. In one embodiment, the operations of FIG. 4 may be implemented by versioning file system 150A. In an alternate embodiment, the operations of FIG. 4 may be implemented by a separate log processor module that interfaces with the versioning file system 150A.

Referring to FIG. 4, at operation 410 a file system object identifier is obtained. In one embodiment, the file system object identifier uniquely identifies a file system object managed by versioning file system 150A. At operation 415 data operations having a matching file system object identifier are retrieved from the log. In one embodiment, the log may be searched sequentially using the file system object identifier as an index, and records in the log having a matching index may be retrieved.

In one embodiment the system optionally implements transactional semantics. Hence, at operation 420 a transaction is opened with the file system object managed by the versioning file system 150A. At operation 425 the file system object is opened for data modifying operations and at operation 430 some or all of the recorded data modifying operations retrieved from the log file are applied to the file system object in the versioning file system 150A. When a data modifying operation record retrieved from the log is applied to the file system object in the versioning file system 150A, the log record may be marked for removal from the log. At operation 435 the file system object is closed and at operation 440 the transaction is committed. In one embodiment the file system object is saved as a separate version of the file system object, which may be associated with previous versions, e.g., by pointers or other suitable means. At operation 445 the records associated with the transaction are purged from the log.

In one embodiment, versions may be time-limited. For example a new version may be created when the time elapsed between data operations in the log exceeds a threshold. This embodiment may be implemented by comparing the difference between timestamps associated with the records in the log, and opening a new version when the elapsed time exceeds a threshold. In another embodiment, specific data operations may trigger the opening of a new version of a data file. For example, in one embodiment the log may be scanned for a “close” operation, and a current version of a file system object may be closed when a close data operation is encountered in the log. A new version may be generated when the next data operation associated with that file system object is encountered. Further, all unapplied changes recorded in the log may be applied to the new version of the file system object.

The operations of FIG. 4 may be repeated for one or more of the file system object managed by versioning file system 150A. In one embodiment, the operations of FIG. 4 may be executed as a background process on processor such as processor 122 or processors 216, 218 on array controllers 210a, 210b. In alternate embodiments the log may be mirrored onto a remote computing system, and the operations of FIG. 4 may be implemented to create one or more versions of the file system objects on the remote computing system.

Embodiments of the subject matter described herein may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

What is claimed is:

1. A method, comprising:
receiving, in a computer-based data storage system, a data operation that changes the contents of a file system;
logging the data operation in a log; and
using the log in a versioning file system to create versions of the file system objects.

2. The method of claim 1, wherein using the log in a versioning file system to create versions of the file system objects comprises:
scanning the log for a close operation; and
generating a new version of the modified file system object when a close operation is located.

3. The method of claim 1, wherein using the log in a versioning file system to create versions of the file system objects comprises:
scanning the log for a close operation;
generating a new version of the file system object when a close operation is located; and
applying all unapplied changes recorded in the log to the new version of the filesystem object.

4. The method of claim 1, wherein using the log in a versioning file system to create versions of the file system objects comprises:
waiting a predetermined amount of time;
generating a new version of the file system object when the predetermined amount of time has passed; and
applying all unapplied changes recorded in the log to the new version of the filesystem object.

5. The method of claim 1, wherein using the log in a versioning file system to create versions of the file system objects comprises generating a new file system object version after a predetermined period of time.

6. The method of claim 1, wherein using the log in a versioning file system to create versions of the file system objects is performed using transactional semantics.

7. The method of claim 1, further comprising:
marking an entry in the log for removal from the log; and
removing the entry after the data operation specified in the entry has been processed.

8. The method of claim 1, further comprising:
mirroring the log onto a remote computer-based storage system; and
using the log in a versioning file system to create versions of the file system data on the remote computing system.

9. A computing system, comprising:
one or more processors;
a memory module communicatively connected to the one or more processors and comprising logic instructions which, when executed on the one or more processors configure the one or more processors to:
receive, in a computer-based data storage system, a data operation that changes the contents of a file system
log the data operation in a log; and
use the log in a versioning file system to create versions of the file system objects.

10. The computing system of claim 9, further comprising logic instructions which, when executed on the one or more processors configure the one or more processors to:
scan the log for a close operation; and
generate a new version of the modified file system object when a close operation is located.

11. The computing system of claim 9, further comprising logic instructions which, when executed on the one or more processors configure the one or more processors to:
scan the log for a close operation;
generate a new version of the file system object when a close operation is located; and
apply all unapplied changes recorded in the log to the new version of the filesystem object.

12. The computing system of claim 9, further comprising logic instructions which, when executed on the one or more processors configure the one or more processors to:
wait a predetermined amount of time;
generate a new version of the file system object when the predetermined amount of time has passed; and
apply all unapplied changes recorded in the log to the new version of the filesystem object.

13. The computing system of claim 9, further comprising logic instructions which, when executed on the one or more processors configure the one or more processors to generate a new file system object version after a predetermined period of time.

14. The computing system of claim 9, further comprising logic instructions which, when executed on the one or more processors configure the one or more processors to create versions of the file system objects is performed using transactional semantics.

15. The computing system of claim 9, further comprising logic instructions which, when executed on the one or more processors configure the one or more processors to:
mark an entry in the log for removal from the log; and
remove the entry after the data operation specified in the entry has been processed.

16. The computing system of claim 9, further comprising logic instructions which, when executed on the one or more processors configure the one or more processors to:
mirror the log onto a remote computer-based storage system; and
use the log in a versioning file system to create versions of the file system data on the remote computing system.

17. A computer program product stored on a computer-readable medium comprising logic instructions which, when executed on a processor, configure the processor to:
receive, in a computer-based data storage system, a data operation'that changes the contents of a file system
log the data operation in a log; and
use the log in a versioning file system to create versions of the file system objects.

18. The computer program product of claim 17, further comprising logic instructions which, when executed on the processor, configures the processor to:
scan the log for a close operation; and
generate a new version of the modified file system object when a close operation is located.

19. The computer program product of claim 17, further comprising logic instructions which, when executed on the processor, configures the processor to:
scan the log for a close operation;
generate a new version of the file system object when a close operation is located; and
apply all unapplied changes recorded in the log to the new version of the filesystem object.

20. The computer program product of claim 17, further comprising logic instructions which, when executed on the processor, configures the processor to:
wait a predetermined amount of time;
generate a new version of the file system object when the predetermined amount of time has passed; and
apply all unapplied changes recorded in the log to the new version of the filesystem object.

21. The computer program product of claim 17, further comprising logic instructions which, when executed on the processor, configures the processor to generate a new file system object version after a predetermined period of time.

22. The computer program product of claim 17, further comprising logic instructions which, when executed on the processor, configures the processor to create versions of the file system objects is performed using transactional semantics.

23. The computer program product of claim 17, further comprising logic instructions which, when executed on the processor, configures the processor to:
mark an entry in the log for removal from the log; and
remove the entry after the data operation specified in the entry has been processed.

24. The computer program product of claim 17, further comprising logic instructions which, when executed on the processor, configures the processor to:
mirror the log onto a remote computer-based storage system; and
use the log in a versioning file system to create versions of the file system data on the remote computing system.

25. A computing system, comprising:
one or more processors;
a file system to manage file system objects associated with input/output operations to the computing system; and
a log filter communicatively coupled to a component of the file system to log file system objects managed by the file system.

26. The computing system of claim 25, wherein the file system comprises:
a network file system, a disk file system, and a versioning file system; and
the log filter intercepts input/output operations flowing between the network file system and one of the disk file system and the versioning file system.

27. The computing system of claim 26, wherein the log filter generates a log from intercepted input/output operations.

28. The computing system of claim 27, wherein the versioning file system uses the log to generate one or more versions of file system objects.

29. A computing system, comprising:
one or more processors;
a file system to manage file system objects associated with input/output operations to the computing system; and
means for creating a log of input/output operations managed by the file system; and
means for using the log to create versions of the file system objects.

30. The computing system of claim 29, wherein the means for creating a log of input/output operations managed by the file system comprises a log filter that intercepts input/output operations passed between file system components.

31. The computing system of claim 29, wherein the means for using the log to create versions of the file system objects comprises a versioning file system communicatively coupled to a log.
